(19) United States
(12) Patent Application Publication
(10) Pub. No.: US 2025/0080391 A1
(43) Pub. Date: Mar. 6, 2025

(54) SYSTEM AND METHOD FOR IMPROVING EFFICIENCY OF YANG BASED CONFIGURATION OF DEVICES

(71) Applicant: HUAWEI TECHNOLOGIES CO., LTD., Shenzhen (CN)

(72) Inventors: Xiang JI, Kanata (CA); Yang QI, Shenzhen (CN); Guokai GOU, Shenzhen (CN); Jian LI, Kanata (CA)

(21) Appl. No.: 18/951,245

(22) Filed: Nov. 18, 2024

Related U.S. Application Data
(63) Continuation of application No. PCT/CN2022/109051, filed on Jul. 9, 2022.

(51) Int. Cl. H04L 41/0246; H04L 41/0853

(52) U.S. Cl. CPC H04L 41/0246; H04L 41/0853

(57) ABSTRACT

The disclosed systems and methods are directed towards: i) creating a specification data type using yet another next generation (YANG) language for indicating device specification data associated with a network device; ii) creating a YANG based device specification data model using the specification data type; iii) creating a YANG based device specification constraint model; iv) sharing the device specification data model and the device specification constraint model with a network management system and the network device; and v) use the device specification data model and the device specification constraint model to create or validate device configure data.

### CROSS-REFERENCE TO RELATED APPLICATIONS

This application is a continuation of PCT Patent Application No. PCT/CN2022/109051, entitled “System and method for improving efficiency of YANG based configuration of devices”, filed Jul. 29, 2022, the entire contents of which are hereby incorporated by reference.

### TECHNICAL FIELD

The present disclosure generally relates to networking and, in particular, to a system, and a method for improving efficiency of YANG based configuration of devices.

### BACKGROUND

Yet Another Next Generation (YANG) is a data modeling language for the definition of data sent over network management protocols such as Network Configuration (NETCONF) and Representational State Transfer Configuration Protocol (RESTCONF). YANG data model describes equipment capabilities and status, facilitating device configuration via management software.

Generally, the YANG protocols are described by Internet Engineering Task Force (IETF). There are many YANG standards that have been developed and evolved so far. For example, Request for Comment (RFC) 6020 (YANG 1.0) and RFC 7950 (YANG 1.1) protocols define YANG, which is a data modeling language and is used to model configuration data, operation data, state data, Remote Procedure Calls (RPC) and notifications for network management protocols.

RFC 6241 protocol defines NETCONF protocol, which provides mechanisms to install, manipulate, and delete the configuration of network devices. RFC 6241 relies on Extensible Markup Language (XML)-based data encoding for the configuration data as well as the protocol messages. RFC 6241 also defines datastore concept, a conceptual place to store and access information, which is a fundamental concept binding the data models written in the YANG data modeling language to network management protocols such as NETCONF and RESTCONF.

RFC 8040 protocol defines a RESTCONF protocol, which is an HTTP-based protocol that provides a programmatic interface for accessing data defined in YANG, using the datastore concepts defined in the NETCONF.

RFC 6244 and RFC 8342 protocol define an architectural framework for datastores based on the experience gained with the initial simpler model, addressing requirements that were not well supported in the initial model.

Modeling with standard data models for configuration data and operational state data with NETCONF/YANG allows a modeler to create a data model to define the organization of the data in that model and to define constraints on that data. In commercial network products, it is common for service providers to provide a variety of devices in the same category to meet different marketing or customer requirements. These variety of devices have similar functionality and feature set, but with different specifications and capabilities, including hardware specification and software specification.

Although the specification parameters can directly influence the device configuration capability, however, typical YANG protocols do not provide an efficient procedure to constrain configuration data with device specification data using a unique YANG data model. Without this, network management (NM) is either unable to configure the device accurately according to the device capability using YANG technology, or unable to manage the specification constraints using a unique YANG data model.

With this said, there is an interest in improving the efficiency of YANG based configuration of devices.

### SUMMARY

The embodiments of the present disclosure have been developed based on developers' appreciation of shortcomings associated with the prior art. By way of example, modeling with standard data models for configuration data and operational state data with NETCONF/YANG assist in creating a data model to define the organization of the data in that model and defining constraints on that data. In commercial network products, it is common for service providers to provide a variety of devices in the same category to meet different marketing or customer requirements. These variety of devices have similar functionality and feature set, but with different specifications and capabilities, including hardware specification and software specification. Although different specifications and capabilities can directly influence the device configuration capability, typical YANG protocols do not provide an efficient procedure to constraint configuration data with specification data using a unique YANG data model.

To this end, developers' of the present disclosure have devised a specification data type, created a YANG based device specification data model using the specification data type and created a YANG based device specification constraint model. The created models are then provided to a network management system and to network device. The network management system may configure a family of network device using the YANG based device specification data model and the YANG based device specification constraint model more efficiently as compared to the traditional techniques.

In accordance with the first broad aspect of the present disclosure, there is provided a method comprising: creating a specification data type using yet another next generation (YANG) language for indicating device specification data associated with a network device; creating a YANG based device specification data model using the specification data type; creating a YANG based device specification constraint model; and sharing the device specification data model and the device specification constraint model with a network management system and the network device

In accordance with any embodiments of the present disclosure, the device specification data includes mixed characteristics of configuration data and state data associated with the device specification model.

In accordance with any embodiments of the present disclosure, the device specification data assists the network management system and the network device in validating the configuration data.

In accordance with any embodiments of the present disclosure, creating the specification data type comprising setting a value of config statement to false in the YANG language, creating a YANG specification statement, and setting a value of the specification statement to true.

In accordance with any embodiments of the present disclosure, the device specification data model defines device specifications associated with the network device.

In accordance with any embodiments of the present disclosure, the device specification constraint model defines constraints rules in accordance with which the network management system configures the network device.

In accordance with the second broad aspect of the present disclosure, there is provided a method comprising: creating, by a network management system, a connection request to a network device; confirming, by the network management system, a connection to the network device; receiving, by the network management system, device specification data associated with the network device, wherein: the device specification data is filled in a yet another next generation (YANG) based device specification data model using a specification data type, the specification data type indicating device specifications associated with the network device; and storing the device specification data in a datastore

In accordance with any embodiments of the present disclosure, the method further comprises receiving, by the network management system, a configuration request; determining, by the network management system, when there is a requirement to compute a new configuration corresponding to the configuration request; and in the event of determining that the new configuration is to be computed, computing, by the network management system, the new configuration based on the device specification data and constraint rules defined in a yet another next generation (YANG) based device specification constraint model, and sending, by the network management system, the new configuration to the network device; and in the event of determining that the new configuration is not to be computed, validating, by the network management system, a configuration associated with the configuration request based on the constraint rules and the device specification data, when the configuration is validated, sending, by the network management system, the configuration to the network device, and when the configuration is not validated, rejecting, by the network management system, the configuration request.

In accordance with any embodiments of the present disclosure, the method further comprises determining, by the network management system, a communication path from the network management system to the network device, when the communication path is determined, sending, by the network management system, at least one of the configuration and the new configuration to the network device, when the communication path is not determined, rejecting, by the network management system, the configuration request.

In accordance with any embodiments of the present disclosure, validating the configuration comprises: determining, by the network management, based on the device specification data stored in the datastore, that the network device has sufficient resources to implement the configuration.

In accordance with any embodiments of the present disclosure, the method further comprises updating the datastore with an updated device specification data received from the network device.

In accordance with the third broad aspect of the present disclosure, there is provided a method comprising including, in a network device, a yet another next generation (YANG) based device specification data model and a YANG based device specification constraint model, wherein: the device specification data model includes a specification data type that defines device specifications associated with the network device, and the device specification constraint model defines constraints rules in accordance with which a network management system configures the network device with a configuration; filling, by the network device, a device specification data in the specification data model using the specification data type; receiving, by the network device, a connection request from the network management system; confirming, by the network device, a connection to the network management system; and sending, by the network device, the device specification data to the network management system.

In accordance with any embodiments of the present disclosure, the method further comprises receiving, by the network device, the configuration from the network management system; validating, by the network device, the configuration in accordance with a configuration model, when the configuration is validated in accordance with the configuration model, validating, by the network device, in accordance with the device specification data model and the device specification constraint model, when the configuration is validated in accordance with the device specification data model and the device specification constraint model, accepting, by the network device, the configuration, and when the configuration is not validated in accordance with the device specification data model and the device specification constraint model, rejecting, by the network device, the configuration; and when the configuration is not validated in accordance with the configuration model, rejecting, by the network device, the configuration request.

In accordance with any embodiments of the present disclosure, the method further comprises detecting, by the network device, any update in the device specifications associated the network device; updating, by the network device, a datastore with updated device specification data; and sending, by the network device, the updated device specification data to the network management system.

In accordance with the fourth broad aspect of the present disclosure, there is provided a system comprising: a processor and a memory, the memory containing instructions executable by the processor whereby the device is configured to perform various methods disclosed in the present disclosure.

In accordance with the fifth broad aspect of the present disclosure, there is provided a computer program, comprising instructions which, when executed on at least one processor of a computing device, cause the at least one processor to carry out various methods disclosed in the present disclosure.

### BRIEF DESCRIPTION OF THE FIGURES

Further features and advantages of the present disclosure will become apparent from the following detailed description, taken in combination with the appended drawings, in which:

FIG. 1 depicts an environment including network devices for use with systems and methods, in accordance with various embodiments of the present disclosure;

FIG. 2A depicts a high-level block diagram of components of the client device/network management system, in accordance with various embodiments of the present disclosure;

FIG. 2B depicts a high-level functional block diagram of a server-network device of environment of FIG. 1, in accordance with various embodiments of the present disclosure;

FIG. 3 illustrates a flowchart representing a process corresponding to a method for improving the efficiency of YANG based configuration of devices, in accordance with various embodiments of the present disclosure;

FIG. 4 illustrates a high-level functional block diagram of a computer system, in accordance with various embodiments of the present disclosure;

FIG. 5 illustrates a flowchart representing a process corresponding to a method for improving efficiency of a client device/network management system, in accordance with various embodiments of the present disclosure;

FIG. 6 illustrates a flowchart representing a process corresponding to a method for improving efficiency of the server-network device, in accordance with various embodiments of the present disclosure;

FIG. 7, FIG. 8, and FIG. 9 illustrate representative examples of device specification data model, device specification constraint model, and device specification data respectively, in accordance with various non-limiting embodiments of the present disclosure;

FIG. 10, FIG. 11, and FIG. 12 illustrate representative examples of device specification data model, device specification constraint model, and device specification data respectively, in accordance with various non-limiting embodiments of the present disclosure.

It is to be understood that throughout the appended drawings and corresponding descriptions, like features are identified by like reference characters. Furthermore, it is also to be understood that the drawings and ensuing descriptions are intended for illustrative purposes only and that such disclosures do not provide a limitation on the scope of the claims.

### DETAILED DESCRIPTION

The instant disclosure is directed to address at least some of the deficiencies of the current technology. In particular, the instant disclosure describes a system and method for improving the efficiency of YANG based configuration of devices.

Unless otherwise defined or indicated by context, all technical and scientific terms used herein have the same meaning as commonly understood by one of ordinary skill in the art to which the described embodiments appertain to.

In the context of the present specification, “client device/network management system” is an application or set of applications that identifies, configures, monitors, updates and troubleshoots network devices either manually or automatically. Thus, some (non-limiting) examples of client device/network management systems can be deployed on computer servers, computer cluster, workstation, personal computers (desktops, laptops, netbooks, etc.), smartphones, and tablets, it may be a web-based application that may be used by a client. Further it is contemplated that the client device/network management system may be an automatic system in network automation and autonomous driving network scenarios. In certain non-limiting embodiments, may be a Software Defined Networking (SDN) controller, an Element Management System (EMS), a Craft Interface (CI) client, or the like. It should be noted that a device acting as a client device/network management system in the present context is not precluded from acting as a server-network device to other client device/network management systems. The use of the expression “a client device/network management system” does not preclude multiple client-device/network management systems being used in receiving/sending, carrying out or causing to be carried out any task or request, or the consequences of any task or request, or steps of any method described herein.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first processor” and “third processor” is not intended to imply any particular order, type, chronology, hierarchy or ranking (for example) of/between the server-network device, nor is their use (by itself) intended to imply that any “second server-network device” must necessarily exist in any given situation. Further, as is discussed herein in other contexts, reference to a “first” element and a “second” element does not preclude the two elements from being the same actual real-world element. Thus, for example, in some instances, a “first” server-network device and a “second” server-network device may be the same software and/or hardware, in other cases they may be different software and/or hardware.

It will be understood that when an element is referred to as being “connected” or “coupled” to another element, it can be directly or indirectly connected or coupled to the other element or intervening elements that may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In the context of the present specification, when an element is referred to as being “associated with” another element, in certain embodiments, the two elements can be directly or indirectly linked, related, connected, coupled, the second element employs the first element, or the like without limiting the scope of present disclosure.

The terminology used herein is only intended to describe particular representative embodiments and is not intended to be limiting of the present technology. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In the context of the present specification, the expression “data” includes data of any nature or kind whatsoever capable of being stored in a database (interchangeably also referred to as datastore). Thus, data includes, but is not limited to audiovisual works (images, movies, sound records, presentations, etc.), data (location data, numerical data, etc.), text (opinions, comments, questions, messages, etc.), documents, spreadsheets, etc.

In the context of the present specification, unless provided expressly otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server-network device or plurality of server-network devices.

Software modules, modules, or units which are implied to be software, may be represented herein as any combination of flowchart elements or other elements indicating performance of process steps and/or textual description. Such modules may be executed by hardware that is expressly or implicitly shown.

With these fundamentals in place, the instant disclosure is directed to address at least some of the deficiencies of the current technology. In particular, the instant disclosure describes a system and method for improving the efficiency of YANG based configuration of devices.

As previously discussed, YANG is a data modeling language for the definition of data sent over network management protocols such as NETCONF and RESTCONF. The YANG data modeling language is maintained by the Network Modeling (NETMOD) working group in the Internet Engineering Task Force (IETF). YANG data model can be used to model both configuration data as well as state data of network devices.

Modeling with standard data models for configuration data and operational state data with NETCONF/YANG assist in creating a data model to define the organization of the data in that model and defining constraints on that data. In commercial network products, it is common for service providers to provide a variety of devices in the same category to meet different marketing or customer requirements. These variety of devices have similar functionality and feature set, but with different specifications and capabilities, including hardware specification and software specification.

Some of the examples of variety of devices, the associated specifications and capability differences that may impact configuration data directly or indirectly are as follows:
i. In one example, a variety of Multiprotocol Label Switching (MPLS) router supports 1,000 Resource ReserVation Protocol (RSVP) Label Switching Paths (LSPs). While in another example, an enhanced model supports 100,000 RSVP LSPs, these LSPs share system memory, CPU time and interface bandwidth with other services;
ii. In one example, one optical service board supports up to 2 port groups. Each port group can support up to 4 ports, ports in each port group can share 1 cross connect chip, and each connect chip can support maximum 10G bps data. In another optical service board in the same category supports up to 4 port groups. Each port group can support up to 8 ports, ports in each port group can share 1 cross connect chip, and each connect chip can support maximum 40G bps data;
iii. In one example, one wireless base station can support up to 400 user equipment (UEs) with up to 100 live connections. In another example, wireless base station in the same family with a smaller memory and slower CPU can support up to 200 UEs with up to 20 live connections; and
iv. In one example, network gateway with silver license can support up to 20G bps data rate and 300 access control rules. In another example, network gateway with gold license can support up to 80G bps data rate and 6000 access control rules.

Although the specification parameters can directly influence the device configuration capability, typical YANG protocols do not provide an efficient procedure to constraint configuration data with specification data using a unique YANG data model.

By way of example, without knowing the device capability and specification, network management (NM) may potentially send invalid configuration that may exceed the device capability and may get rejected by the device. In a network scope configuration transaction, when a configuration change is rejected by one device in the network, all other devices in the network that have already made the requested changes may be required to roll back the changes, and NM may be required to provide/calculate new configuration.

Some of the non-limiting scenarios where NM is managing the devices are discussed below. One scenario may be where one NM is managing two devices device (A) and device (B) of the same category. Both the devices (A) and (B) support service (X). The support service (X) requires one resource (M) from the devices (A) and (B). Based on hardware capability, the device (A) has 1000 resources (M), while the device (B) has 100,000 resources (M).

The issue with the above scenario is to detect of different specification data, by the NM, and avoid configuring 1001 items of service (X) to the device (A). As the device (A) has a constraint of 1000 resources (M). Also, the information associated with the device capabilities are preferably required to be consistent with the NM. In case, the device (A) and (B) are modeled with different YANG data models, the NM may lose the capability of using a common model to multiple devices of the same family that support the same feature set. However, with different specifications and/or capabilities, it may complicate the NM software, especially when the number of device variety is large.

Another scenario may be where one NM is managing one device (C), and the device (C) supports service (X) and service (Y). The service (X) requires one resource (P), one resource (Q) and one resource (R) from the device (C). Similarly, the service (Y) requires one resource (P), one resource (Q) and one resource (R) from the device (C). Based on the hardware capability, the device (C) has 50 resources (P), 120 resources (Q) and 200 resources (R).

The issue with the above scenario is coordination of the configuration between the service (X) and service (Y). By way of example, the NM preferably required to avoid configuring 40 services (X) and 90 services (Y), due to the constraint on the resource (Q). As the number of resources (Q) is 120 and the device (C) may not be able to configure the device with the additional services.

The conventional techniques for configuring the devices exacerbate the process of configuration.

To this end, there is an interest in developing the systems and methods for improving the efficiency of YANG based configuration of devices.

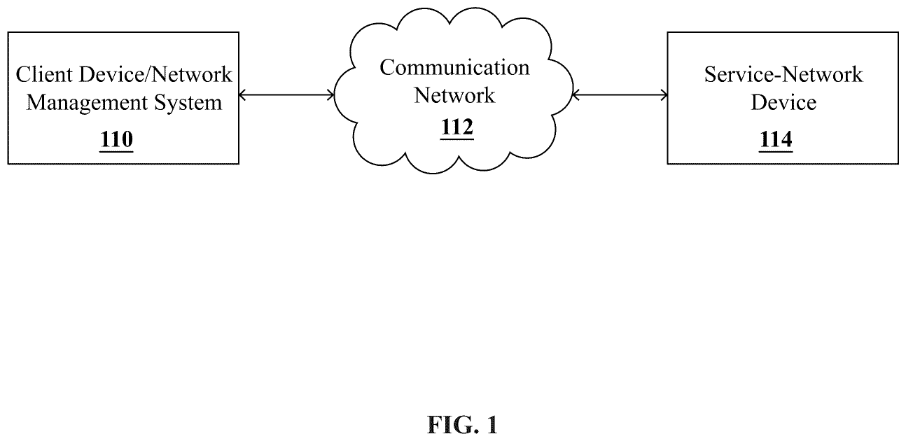

FIG. 1 depicts an environment 100 including network devices for use with systems and methods, in accordance with various embodiments of the present disclosure. The environment 100 may include multiple client device/network management systems 110 (for the purpose of simplicity only one client device/network management system 110 has been illustrated) located at different geographic locations that are configured to communicate with each other via a communication network 112 and multiple server-network devices 114 (for the purpose of simplicity only one server-network device 114 has been illustrated). In certain embodiments, multiple client device/network management systems 110 may be associated with individual users (such as users of personal computers, laptops, desktops, or the like) or a part of network (such as client device/network management systems in an organization, etc.).

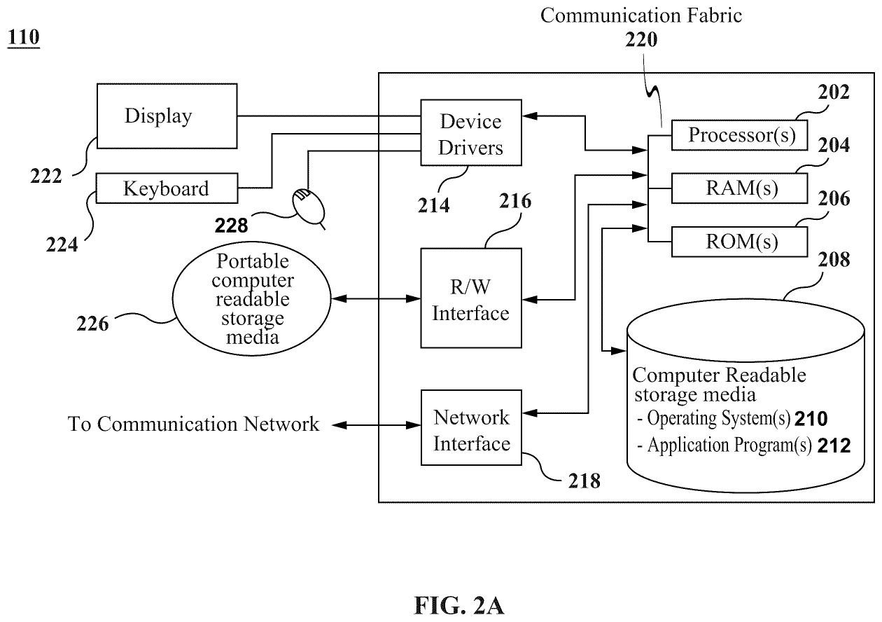

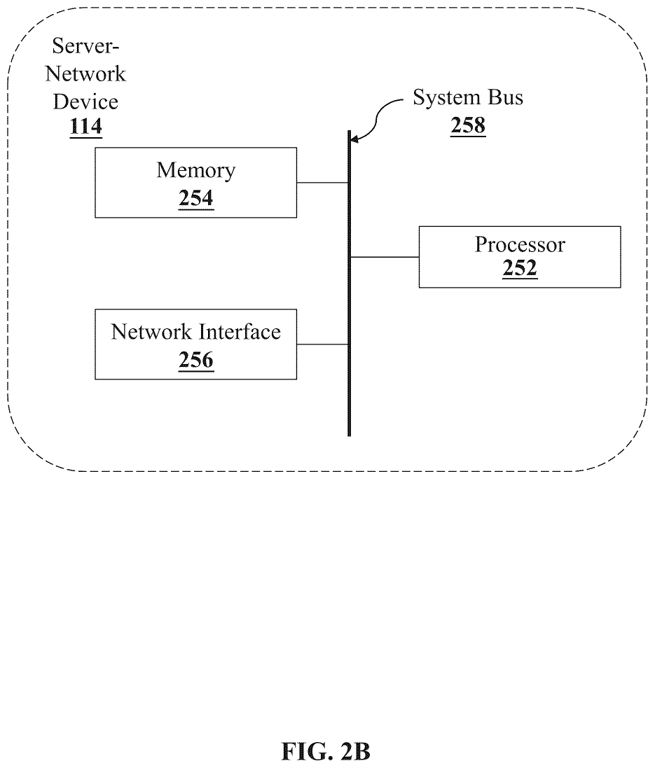

FIG. 2A depicts a high-level block diagram of components of the client device/network management system 110, in accordance with various embodiments of the present disclosure. It should be appreciated that FIG. 2A provides only an illustration of one implementation of the client device/network management system 110 and does not imply any limitations with regard to the environments in which different embodiments may be implemented. Many modifications to the depicted environment can be done to implement the client device/network management system 110 without departing from the principles presented herein. The client device/network management system 110 may be a server-network device, a desktop computer, a laptop computer, or any device that may be configured to implement the present technology, as should be understood by a person skilled in the art.

As shown, the client device/network management system 110 employs one or more processors 202, one or more computer-readable random access memories (RAMs) 204, one or more computer-readable read only memories (ROMs) 206, one or more computer-readable storage media 208, device drivers 214, a read/write (R/W) driver interface 216, a network interface 218, all interconnected over a communication fabric 220. The communication fabric 220 may be implemented by any architecture designed for passing data and/or control information between processors (such as microprocessors, communications and network processors, etc.), system memory, peripheral devices, and any other hardware components within a system.

One or more operating systems 210 and one or more application programs 212 are stored on one or more of computer-readable storage media 208 for execution by one or more of the processors 202 via one or more of respective RAMs 204 (which typically include a cache memory). In the illustrated embodiment, each of the computer-readable storage media 208 maybe a magnetic disc storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The R/W driver interface 216 reads from and writes to one or more portable computer-readable storage media 226. The application programs 212 may be related to improving the efficiency of YANG based configuration of devices and stored on one or more of portable computer-readable storage media 226, read via the respective R/W driver interface 216 and loaded into the respective computer-readable storage media 208.

Further, network interface 218 may be based on a TCP/IP adapter card or wireless communication adapter (such as a 4G wireless communication adapter using OFDMA technology). The application programs 212 on the client device/network management system 110 may be downloaded to the client device/network management system 110 from an external computer or external storage device via a communication network (for example, the Internet, a local area network or other wide area network or wireless network) and network interface 218. From network interface 218, application programs 212 may be loaded onto the computer-readable storage media 208. The client device/network management system 110 may connect to routers, firewalls, switches, gateway computers and/or edge server-network devices of the communication network using copper wires, optical fibers, wireless transmission, and the like.

The client device/network management system 110 may also include a display screen 222, a keyboard or keypad 224, and a computer mouse or touchpad 228. The device drivers 214 may interface with display screen 222 for imaging, with the keyboard or the keypad 224, with a computer mouse or touchpad 228, and/or with display screen 222 (which may be a touch-sensitive display) for alphanumeric character entry and user selections. The device drivers 214, R/W driver interface 216 and network interface 218 may comprise hardware and software (stored on the computer-readable storage media 208 and/or the ROM 206).

FIG. 2B depicts a high-level functional block diagram of server-network device 114 of environment 100 of FIG. 1, in accordance with various embodiments of the present disclosure. In one embodiment, the server-network device 114 may be a device that may consolidate a functionality of an Internet Router, a Multiprotocol Label Switching (MPLS) router or switch, a Multi-Service Provisioning Platform (MSPP), Digital Cross-Connect (DCS), Ethernet and/or Optical Transport Network (OTN) switch, Wave Division Multiplexed (WDM)/DWDM platform, Packet Optical Transport System (POTS), etc. into a single, high-capacity intelligent switching system. In another embodiment, the server-network device 114 may be any of an OTN Add/Drop Multiplexer (ADM), a Multi-Service Provisioning Platform (MSPP), a Digital Cross-Connect (DCS), an optical cross-connect, a POTS, an optical switch, a router, a switch, a WDM/DWDM terminal, an access/aggregation device, a wireless base station, etc. That is, the server-network device 114 may be any of digital, wireless (Radio Frequency (RF)), and/or optical system including switching of channels, timeslots, tributary units, wavelengths, etc. Also, the server-network device 114 may be a physical device as well as a virtual device (e.g., Virtual Network Function (VNF)).

It is contemplated that the server-network device 114 may communicate with other server-network devices 114 such as, without limitation, a Software-Defined Networking (SDN) controller, an orchestrator, a Network Management System (NMS), and Element Management System (EMS), etc.

In certain non-limiting embodiments, the server-network device 114 may include a processor 252, a memory 254 and a network interface 256. It is to be noted that the server-network device 114 may include other components, but such components have not been illustrated in FIG. 2B for the purpose of simplicity.

In certain non-limiting embodiments, the processor 252 of server-network device 114 may include one or more of a CPU, an accelerator, a microprocessor, a GPU, an ASIC, a FPGA, a dedicated logic circuitry, a dedicated artificial intelligence processor unit, or combinations thereof.

The memory 254 may include volatile memory (e.g., RAM) and non-volatile or non-transitory memory (e.g., a flash memory, magnetic storage, and/or a ROM). The non-transitory memory(ies) stores a platform that controls the overall operation of server-network device 114. The platform, when executed by processor 252, implements application programs related to improving the efficiency of YANG based configuration of devices.

The network interface 256 may include one or more wireless transceivers configured for wireless communications with communication network 112, or one or more network adaptors configured for wired communications with communication network 112. In general, network interface 256 may be configured to correspond with the network architecture that is used to implement a link for communications between server-network device 114 and communication network 112. In certain embodiments, network interface 256 may be implemented in a similar manner as network interface 218 has been implemented.

The server-network device 114 may include a system bus 258 for communicatively coupling the processor 252, the memory 254 and the network interface 256 to one another. For example, the system bus 258 may be a backplane, midplane, a bus, optical and/or electrical connectors, or the like.

It is to be noted that server-network device 114 is shown as a standalone computer. However, the implementation of various other embodiments of the present disclosure may include any client-server-network device model where client device/network management system 110 may run a client version of the application programs related to improving the efficiency of YANG based configuration of devices. Other examples of server-network device 114 may include a distributed computing system that runs the server-network device version of the application programs related to improving the efficiency of YANG based configuration of devices, a virtual machine (or virtual machines) instantiated by the infrastructure of a public or private cloud, or a cloud service provider that provides the application programs related to improving the efficiency of YANG based configuration of devices as a service (SaaS). Such implementations or any other similar implementation should not limit the scope of the present disclosure.

In various non-limiting embodiments, the client device/network management system 110 may be configured to provide various sorts of configurations to the server-network device 114. As previously discussed, for the purpose of simplicity only on server-network device 114 has been illustrated. In various non-limiting embodiments, the server-network device 114 may include a plurality of server-network devices 114. Also, the plurality of server-network devices 114 may have a same or different specification and/or capability, including hardware specification and software specification.

Various techniques discussed in the present disclosure may be directed towards extending the YANG data types, YANG datastore and the network management datastore architecture to improve the efficiency of YANG based configuration of devices.

Various non-limiting embodiments of the present disclosure may rely on same YANG data model for a given device family instead of relying on different per device YANG data models. In other words, devices (for example, the plurality of server-network devices 114) belonging to the same family and having different specification and/or capability may share the same YANG data model. The YANG data model, in accordance with various non-limiting embodiments, may include a data schema, the device specification and capability difference in the plurality of server-network devices 114 may be carried by the filled data using the data schema.

In various non-limiting embodiments, the hidden or hard coded background information associated with the specifications and capabilities of the plurality of server-network devices 114 may be replaced with structured data model. This may result in decoupling of the plurality of server-network devices 114 and the client device/network management system 110, standardizes the management interface, increases device interoperability and network programmability.

Moreover, instead of statically hard coding or transferring device specifications and capabilities via conventionally used proprietary methods, such hard code with XML, Excel spread sheets, YAML files, formatted text files etc., in various non-limiting embodiments, device specifications and capabilities may be transferred to the client device/network management system 110 by using the modeled data instead of the YANG data model itself. Such technique may result in moving the specification data from static model schema to dynamic modeled data and allowing dynamically refreshing device specification and capability changes to the client device/network management system 110 on the fly.

In addition to using same specification and constraint models to handle the specification data difference, the environment 100 may rely on a centralized specification datastore for all device resources. The device specification and constraint models may be used to describe the constraint rules between specification data and configuration data in the structured schema. The specification and constraint models may cross-reference the specification data to validate the configuration data. In doing so, each service/feature may require focusing merely on the respective resources and may not require evaluating cross service/feature dependencies. In other words, the specification and constraint models may be the centralized place to coordinate resources between services/features.

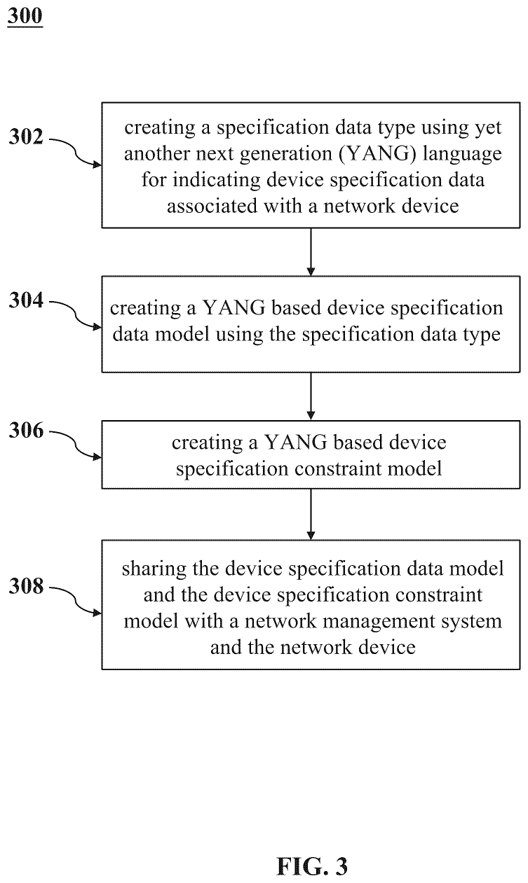

FIG. 3 illustrates a flowchart representing a process 300 corresponding to a method for improving the efficiency of YANG based configuration of devices, in accordance with various embodiments of the present disclosure.

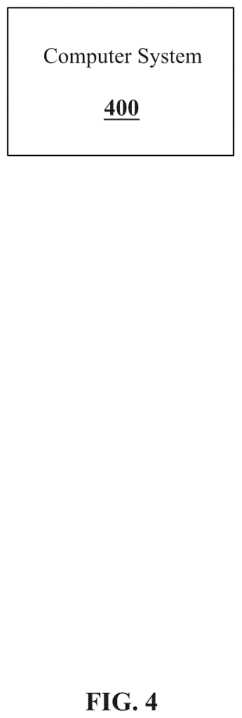

It is to be noted the process 300 may be implemented on any suitable computer system (for example, a computer system 400 illustrated in FIG. 4) including one or more processors and one or more memory elements. The one or more memory elements may be configured to store the instructions which, when implemented by the one or more processors, cause the one or more processors to carry out the method 300. In certain non-limiting embodiments, the computer system 400 may be implemented similar to the client device/network management system 110 (previously discussed in FIG. 2A). In other words, the computer system 400 may include the components similar to those included the client device/network management system 110.

Further, the computer system 400 may be configured to communicate with the client device/network management system 110 and the server-network device 114 using any suitable communication technique, such as wireless communication technique, wired communication technique or the like. Even though the computer system 400 has been illustrated as a separate system, however, the computer system 400 may be implemented on the client device/network management system 110 or on the server-network device 114 without limiting the scope of present disclosure.

The process 300 commences at step 302 where the computer system 400 creates a specification data type using the YANG language for indicating device specification data associated with the server-network device 114.

As previously discussed, the YANG data model may be used to model configuration data as well as state data of the server-network device 114. In general, configuration data comprises a set of writeable data of the server-network device 114 required to transform the server-network device 114 from an initial state to a current state. State data comprises additional data of the server-network device 114 that is not configuration data such as read-only status information and collected statistics. The computer system 400 may create the specification data type to indicate the device specifications associated with server-network device 114.

In certain non-limiting embodiments, the specification data type may be used by the server-network device 114 to provide information associated with the specifications of the server-network device 114 to the client device/network management system 110. The specifications may include a number of a given type of resources present in the server-network device 114. The resources may include for example processors, memory elements, application contexts, handles, link bandwidth, chipset throughput bandwidth or the like. How the server-network device 114 fills the device specification in the specification data type will be discussed later in the disclosure.

In certain non-limiting embodiments, the device specification may include mixed characteristics of configuration data and state data associated with the device specification model. Similar to the configuration data, the device specification data may participate in configuration data validation. The device specification data may assist the client device/network management system 110 and the server-network device 114 in validating the configuration data. In certain non-limiting embodiments, when the client device/network management system 110 initiates a configuration of the server-network device 114 with certain services (for example optical trail, OTN path, RSVP tunnel, Layer 2 Provider Provisioned Virtual Private Network (L2VPN) service, Layer 2 Provider Provisioned Virtual Private Network (L3VPN) service, wireless call connection, or the like), based on the device specifications data, the server-network device 114 may identify that the server-network device 114 is capable or not to be configured with a given service.

Also, similar to the operational data, the device specification data may not be writeable by the client device/network management system 110 from operator point of view. However, the server-network device 114 may optionally write the device specification data using the specification data type. In some non-limiting embodiments, the server-network device 114 may write the device specification data when the server-network device 114 is in factory mode and is about to initiate the initial communication with the client device/network management system 110.

In some non-limiting embodiments, the computer system 400 may create the specification data type by setting a value of “config” statement to “false” in the YANG language. The computer system 400 may create a YANG “specification” statement and may set a value of the “specification” statement to “true”.

In other non-limiting embodiments, the computer system 400 may set the value of “config” statement to “true”. However, in such embodiments, the computer system 400 may use access control to prevent write access of the “config” statement by an operator of the client device/network management system 110.

The process 300 advances to step 304 where the computer system 400 creates a YANG based device specification data model using the specification data type. The computer system 400 may include the specification data type in the YANG based device specification data model. As such, the device specification data model may define device specifications associated with the network device. By way of example, the device specification model may characterize a type of device and a quantity of the device associated with the server-network device 114.

The process 300 advances to step 306 where the computer system 400 creates a YANG based device specification constraint model. The YANG based constraint model may define constraints rules in accordance with which the client device/network management system 110 may configure the server-network device 114. The constraint rules may include information associated with the requirement of device resources associated with the server-network device 114 to perform the services to be configured on the server-network device 114 by the client device/network management system 110.

It is to be noted that how the computer system 400 creates the device specification data model and the device specification constraint model should not limit the scope of present disclosure. In certain non-limiting embodiments, the modeling of the device specification data model and the device specification constraint model may rely on existing YANG language, including language standard syntax and user extended syntax.

In certain non-limiting embodiments, a range of the constraints of the device specification data may be modeled with standard or extended YANG data type and constrain statements. By way of example, for a family of the server-network device 114 having a constraint that a total bandwidth on each family member of the server-network device 114 is 400G. Such constraint may be modeled, but not limited to, with “range”, “pattern”, “max-elements”, “min-elements”, “default”, “must” YANG statements.

In certain non-limiting embodiments, constraints among specification data (e.g., dependency, resource sharing, etc.) may be modeled with standard or extended YANG constrain statements. By way of example, for a family of the server-network device 114 having a full-sized shelf, shelf-level cross connect capability having maximum value is 800G may be modeled with “when”, “must” YANG statements.

In certain non-limiting embodiments, constraints between resources and services/features may be modeled with standard or extended YANG constrain statements. By way of example, while configuring a new optical cross connect on a family of the server-network device 114 each family member may have different specification constraints. By way of example, a total Network Element (NE) level cross connections may not exceed NE's cross connection specification limit, a total shelf-level cross connections may not exceed shelf's cross connection specification limit, a total service board-level bandwidth may not exceed the board's bandwidth specification limit, a total service board-level cross connections may not exceed the connected port's bandwidth specification limit or the like. Such constraints may use but are not limited to, XPATH1.0 expressions as defined in YANG, and use “when”, “must” statements in YANG for cross module constraints.

It is to be noted that the where the constrain rules are implemented should not limit the scope of present disclosure. In certain non-limiting embodiments, the computer system 400 may include the constraint rules in one or more of the device specification data model, the device specification constraint model, service/feature models. In certain non-limiting embodiments, the computer system 400 may store the constraint rule in a separate YANG file with YANG augment statement to extend the models mentioned above.

Alternative, in certain non-limiting embodiments, the computer system 400 may rely on W3C standard query language to simplify the modeling. The computer system 400 may XPATH standards XPATH 2.0, XPATH 3.0, XPATH 3.1, XQUERY or other query languages.

Finally, the process 300 advances to step 308, where the computer system 400 may share the device specification data model and the device specification constraint model with the client device/network management system 110 and the server-network device 114. It is to be noted that how the computer system 400 shares the device specification data model and the device specification constraint model should not limit the scope of present disclosure. In some embodiments the sharing may be on a wireless communication channel. In other embodiments, the sharing may be on a wired communication channel. The sharing may be referred to as transmitting of the device specification data model and the device specification constraint model from the computer system 400 to the client device/network management system 110 and the server-network device 114. The client device/network management system 110 and the server-network device 114 may be configured to install the device specification data model and the device specification constraint model.

In certain non-limiting embodiments, the computer system 400 may statically publish the device specification data model and the device specification constraint model to a server or cloud. The client device/network management system 110 and the server-network device 114 may download the device specification data model and the device specification constraint model from the server or cloud.

In certain non-limiting embodiments, the computer system 400 may provide the device specification data model and the device specification constraint model as a part of device software package. In some embodiments, the client device/network management system 110 and the server-network device 114 may get the device specification data model and the device specification constraint model from the device software package. In other embodiments, the client device/network management system 110 and the server-network device 114 may get the device specification data model and the device specification constraint model from NETCONF RPC “get-schema” at run time.

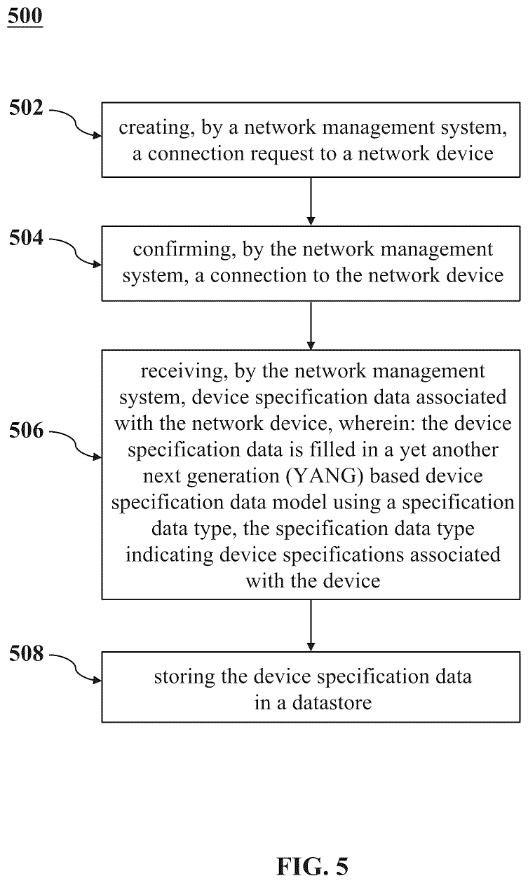

FIG. 5 illustrates a flowchart representing a process 500 corresponding to a method for improving efficiency of the client device/network management system 110, in accordance with various embodiments of the present disclosure. The process 500 may be implemented on the client device/network management system 110.

The process 500 commences at step 502 where the client device/network management system 110 creates a connection request to the server-network device 114. In certain non-limiting embodiments, the client device/network management system 110 may transmit the connection request to the server-network device 114. How the connection request is created and transmitted should not limit the scope of present disclosure.

The process 500 advances to step 504 where the client device/network management system 110 confirms a connection to the server-network device 114. In certain non-limiting embodiments, based on the connection request received from the client device/network management system 110, the server-network device 114 may transmit an acknowledgement signal transmit towards the client device/network management system 110. In certain non-limiting embodiments, the acknowledgement may be based on NETCONF/RESTCONF handshake. Based on the acknowledgment signal, the client device/network management system 110 may confirm the connection to the server-network device 114.

The process 500 proceeds to step 506 where the client device/network management system 110 receives the device specification data associated with the server-network device 114. In certain non-limiting embodiments, after the connection is established between the client device/network management system 110 and the server-network device 114, the server-network device 114 may provide the associated device specification data to the client device/network management system 110. The device specification data may be filled by the server-network device 114 in the YANG based device specification data model using the specification data type. As previously noted, the specification data type may indicate device specifications associated with the server-network device 114.

The process 500 advances to step 508, where the client device/network management system 110 stores the device specification data in a centralized datastore. The client device/network management system 110 may consult the datastore for validation of a configuration request. The centralized datastore for all device specification data, each configuration/service/feature may require focusing on its own respective resources without any cross configuration/service/feature dependencies.

In certain non-limiting embodiments, the client device/network management system 110 may receive the configuration request. The configuration request may be referred to as a configuration action requested by the operator of the client device/network management system 110, a network automation API call from higher level applications or any similar action to request a change in the configuration of the client device/network management system 110. Such change may be referred to as addition of parameters, deletion of parameters or modification of parameters.

The client device/network management system 110 may determine if there is a requirement to compute a new configuration corresponding to the configuration request. In certain non-limiting embodiments, in the event of determining that the new configuration is to be computed, the client device/network management system 110 may compute the new configuration based on the device specification data and constraint rules. The client device/network management system 110 may send the new configuration to the server-network device 114.

In certain non-limiting embodiments, in the event of determining that the new configuration is not to be computed, the client device/network management system 110 may validate a configuration associated with the configuration request based on the constraint rules and the device specification data. In certain non-limiting embodiments, to validate the configuration, based on the device specification data stored in the datastore, the client device/network management system 110 may determine if the server-network device 114 may have sufficient resources to implement the configuration.

In case, the configuration is validated, the client device/network management system 110 may send the configuration to the server-network device 114. On the other hand, in case the configuration is not validated, the client device/network management system 110 may reject the configuration request.

Once the configuration is validated, in certain non-limiting embodiments, the client device/network management system 110 may determine a communication path from the client device/network management system 110 to the network-server device 114. When the communication path is determined, the client device/network management system 110 may send at least one of the configuration and the new configuration to the network device to the server-network device 114. Sending the at least one of the configuration and the new configuration may be a process of assigning network settings, policies, flows, and controls to deliver a service, or a recognizable part of a service However, if the communication path is not determined, the client device/network management system 110 may reject the configuration request.

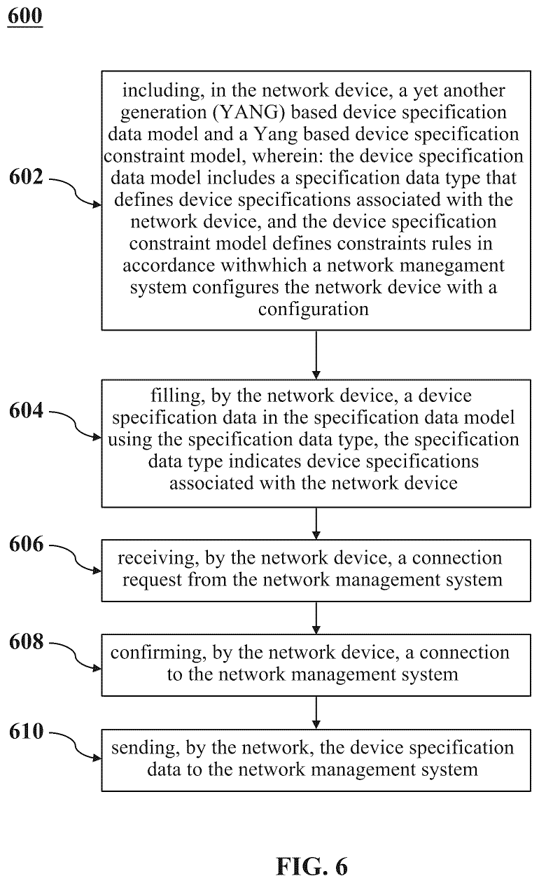

FIG. 6 illustrates a flowchart representing a process 600 corresponding to a method for improving efficiency of the server-network device 114, in accordance with various embodiments of the present disclosure. The process 600 may be implemented on the server-network device 114.

The process 600 commences at step 602 where the YANG based device specification data model and the YANG based device specification constraint model are included in the server-network device 114. As previously noted that the computer system 400 may provide the device specification data model and the device specification constraint model to the server-network device 114. Further, the device specification data model may include the specification data type. The specification data type may be used by the server-network device 114 to define the associated device specifications. Also, the device specification constraint model may define constraints rules in accordance with which the client device/network management system 110 may configure the server-network device 114 with the configuration.

The process 600 advances to step 604 where the server-network device 114 fills the specification data in the device specification data model using the specification data type. As previously noted, that the device specification data may indicate device specifications associated with the server-network device 114.

It is to be noted that how the server-network model 114 fills should not limit the scope of present disclosure. In certain non-limiting embodiments, the server-network device 114 may rely on internal network management software, which may have for example, special access privilege mode, factory mode to change the device specification data and/or fill the device specification data. In the network management software, in special access privilege mode, the device specification data may be treated same as configuration data on both the client device/network management system 110 as well as the server-network device 114.

In certain non-limiting embodiments, the server-network device 114 may rely on a load build script or a software application to fill the data using software built-in data. In certain non-limiting embodiments, the server-network device 114 may rely on the load build script or the software application to fill the data with the assistance of a product specification server, product specification spread sheets or any other suitable data file formats and data sources.

In certain non-limiting embodiments, the device specification data may be created at product development stage, such as load build time or software packing stage during a software release. The device specification data may be presented as a part of the device software package or a patch. In certain non-limiting embodiments, the device specification data may be dynamically filled by device software of the server-network device 114 at the time of the device initialization/startup.

The process 600 advances to step 606, where the server-network device 114 receives the connection request from the client device/network management system 110. As previously noted, the client device/network management system 110 may transmit the connection request to the server-network device 114.

The process 600 advances to step 608, where the server-network device 608 confirms the connection with the client device/network management system 110. In certain non-limiting embodiments, based on the connection request received from the client device/network management system 110, the server-network device 114 and the client device/network management system 110 may perform NETCONF/RESTCONF handshake. Based on the NETCONF/RESTCONF handshake, the server-network device 114 may confirm the connection to the client device/network management system 110.

The process 600 proceeds to step 610 where the network-server device 114 sends the device specification data to the client device/network management system 110. It is to be noted that the manner by which the server-network device 114 provides/sends the device specification data to the client device/network management system 110 should not limit the scope of present disclosure.

In some non-limiting embodiments, the server-network device 114 may rely on YANG notification remote procedure call (RPC) based specification data notification model. In other non-limiting embodiments, the server-network device 114 may rely on YANG push procedure defined in RFC 8641. In certain non-limiting embodiments, the server-network device 114 may create a NETCONF/RESTCONF RPC <get-specification>. The <get-specification> may function in a similar manner to the <get-config>, with only difference is that the server-network device 114 may configure <get-specification> with specification data instead of configuration data. In other non-limiting embodiments, the server-network device 114 may rely on NETCONF/RESTCONF RPC <get> with parameters of the root node in the device specification model. The server-network device 114 may select one or more techniques discussed above to provide the device specification data to the client device/network management system 110.

In certain non-limiting embodiments, in addition to or alternatively, the server-network device 114 may store the device specification data to the datastore. It is to be noted that in addition to or alternatively, the client device/network management system 110 may store the device specification data. In some scenarios, there may be a change in the device specifications, for example due to addition and/or removal of new device components, or the server-network device 114 being operated under special conditions, such as overload mode, maintenance mode or license type change, etc. In such scenarios, the server-network device 114 may determine any change/update in the associated device specifications. The server-network device 114 may update the datastore with the updated device specification data. The server-network device 114 may send the updated specification data to the client device/network management system 110.

In certain non-limiting embodiments, the server-network device 114 may receive the configuration from the client device/network management system 110. The server-network device 114 may validate the configuration. In other words, the server-network device 114 may verify that the server-network device 114 is having a capacity of implementing the configuration. In certain non-limiting embodiments, the server-network device 114 may validate the configuration in accordance with the predefined configuration model. Once the configuration is validated, the server-network model 114 may validate the configuration in accordance with the device specification model and the device constraint model. When the configuration is validated in accordance with the device specification data model and the device specification constraint model, the server-network device 114 may accept the configuration. However, when the configuration is not validated in accordance with the configuration model or in accordance with the device specification data model and the device specification constraint model, the server-network device 114 may reject the configuration.

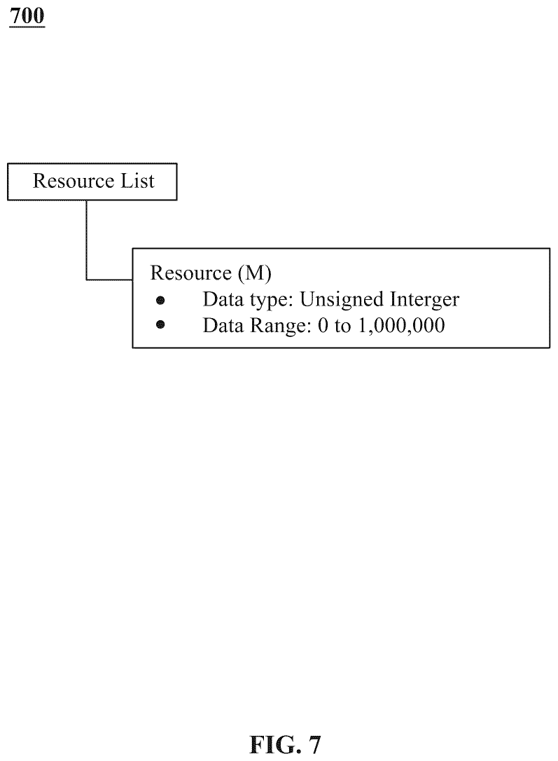

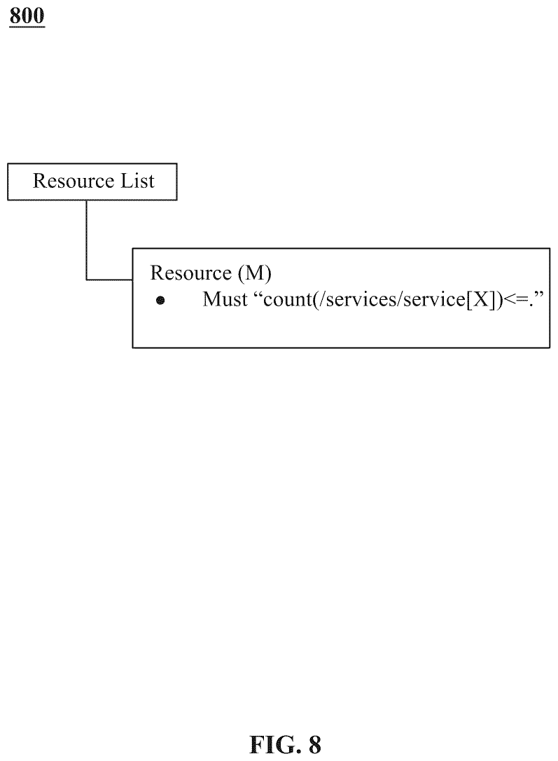

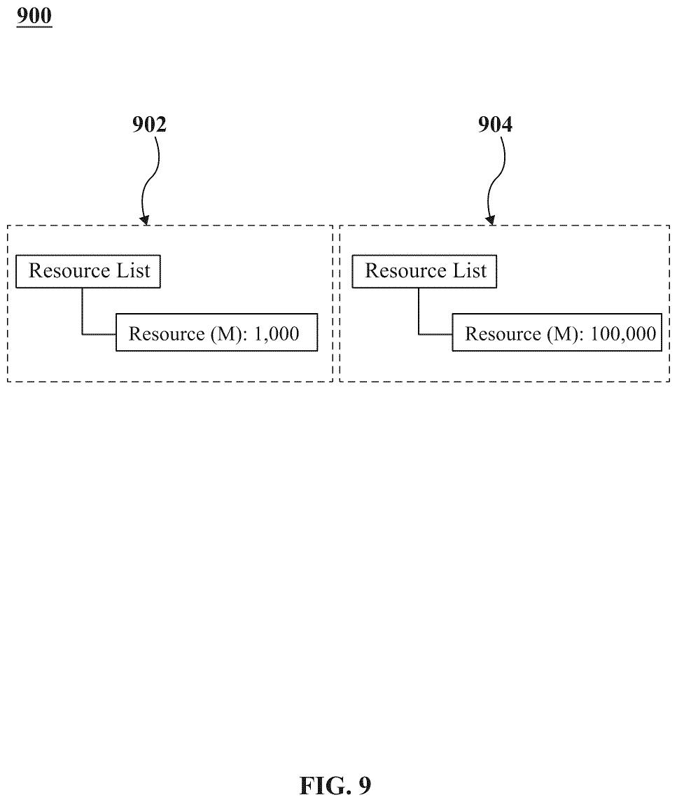

FIG. 7, FIG. 8, and FIG. 9 illustrate representative examples of device specification data model 700, device specification constraint model 800, and device specification data 900 respectively, in accordance with various non-limiting embodiments of the present disclosure. In certain non-limiting embodiments, the client device/network management system 110 and the server-network device 114 may have the device specification model 700 and the device specification constraint model 800. In the representative examples of FIG. 7, FIG. 8, and FIG. 9, the client device/network management system 110 intends to configure a family of the server-network device 114.

In certain non-limiting embodiments, the client device/network management system 110 may configure the device specification model 700 by modeling the resource (M) (also referred to as a specification) as list member in a resource list, set the data type, range attributes, and other generic constrains that the family of the server-network device 114 may follow. By way of example, the data type may be: Unsigned Integer and the Data Range may be: 0 to 1,000,000. The resource (M) may represent a particular type of specification associated with the server-network device 114.

In certain non-limiting embodiments, the client device/network management system 110 may configure the device specification constraint model 800 with the constraint rules on the resource (M) corresponding to a service (X). The service (X) may be the configuration with which the client device/network management system 110 intends to configure the family of the server-network device 114. The constrain rule “count (/services/service [X])<=.” may verify that each one of the devices in the family of the server-network device 114 has sufficient resources to implement the service (X).

In certain non-limiting embodiments, each device of the family of the server-network device 114 may fill the respective device specification data in the device specification data model. It is to be noted that each device of the family of the server-network device 114 may use the same device specification data model. As shown, in FIG. 9, a first device (A) in the family of the server-network device 114 may fill the device specification data 902 with the respective specification values. By way of example, the first device (A) may have 1000 resources (M) and the first device (A) may fill the resource list with a value of 1000. In a similar manner a second device (B) in the family of the server-network device 114 may fill the device specification data 904 with the respective specification values. By way of example, the second device (B) may have 100,000 resources (M) and the first device (A) may fill the resource list with a value of 100,000. Both the first device (A) and the second device (B) may forward the specification data 902 and 904 to the client device/network management system 110.

In the above scenario, it is assumed that the resources of first device (A) and the second device (B) have already occupied with 1000 services. The client device/network management system 110 may receive a new request from a user to configure the first device (A) and the second device (B) with the service (X). The client device/network management system 110 may validate the new request. Based on the above scenario, where all the resources of the first device (A) are already occupied with other services, the client device/network management system 110 may reject the new request of the configuration of the first device (A) and accept the new request of the configuration of the second device (B).

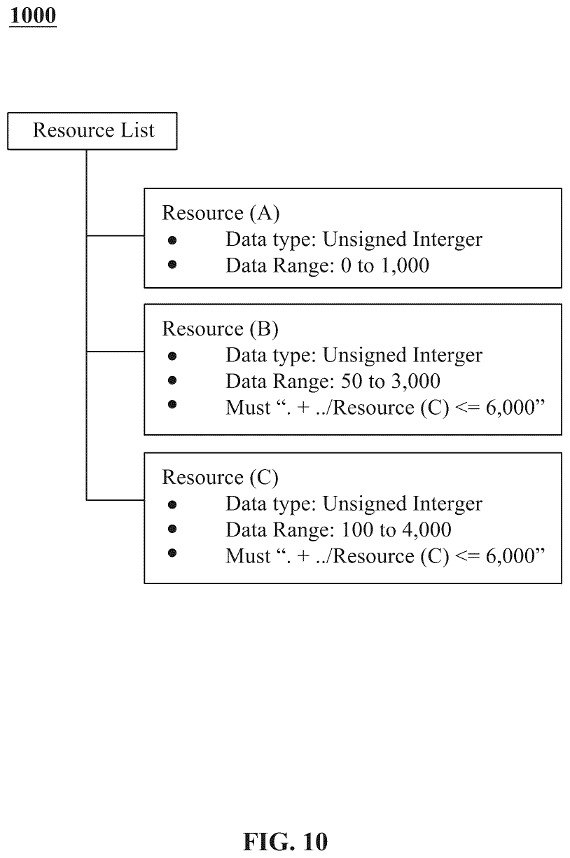

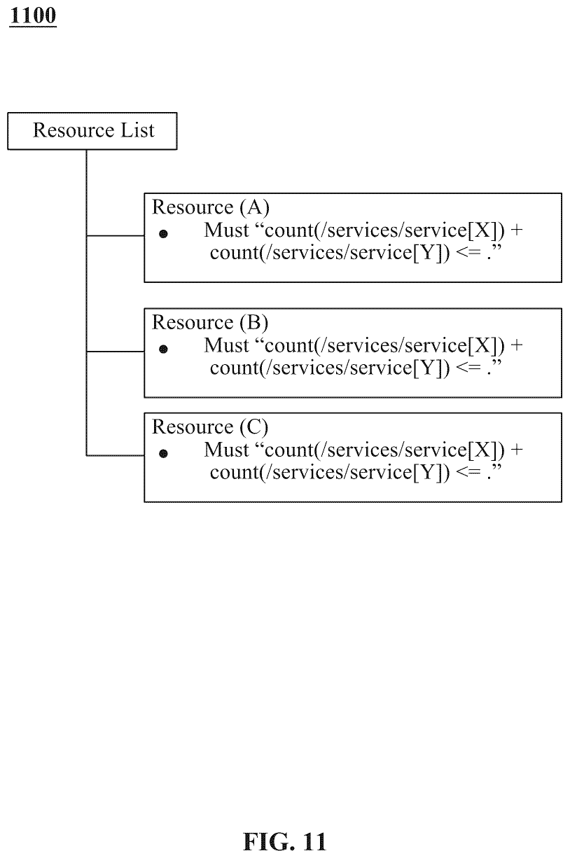

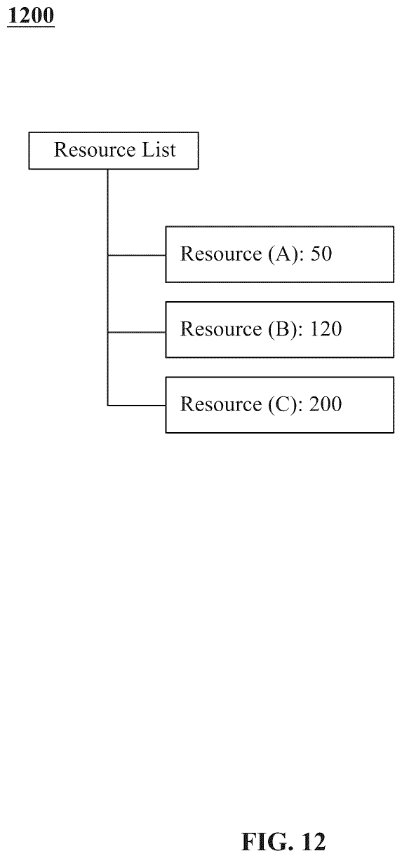

FIG. 10, FIG. 11, and FIG. 12 illustrate representative examples of device specification data model 1000, device specification constraint model 1100, and device specification data 1200 respectively, in accordance with various non-limiting embodiments of the present disclosure. In certain non-limiting embodiments, the client device/network management system 110 and the server-network device 114 may have the device specification model 1000 and the device specification constraint model 1100. In the representative example of FIG. 10, FIG. 11, and FIG. 12, the client device/network management system 110 intends to configure the server-network device 114 with more than one service/feature.

In certain non-limiting embodiments, the client device/network management system 110 may configure the device specification model 1000 by modeling the resource (A), resource (B), and resource (C) as list members in a resource list, set the data type, range attributes, and other generic constrains that the server-network device 114 may follow.

By way of example, corresponding to the resource (A), the client device/network management system 110 may set the data type: Unsigned Integer and the Data Range may be: 0 to 1,000. Corresponding to the resource (B), the client device/network management system 110 may set the data type: Unsigned Integer, the Data Range may be: 50 to 3,000 and an intra-model constraint “.+../resource (C)<=6,000”. Corresponding to the resource (C), the client device/network management system 110 may set the data type: Unsigned Integer, the Data Range may be: 50 to 3,000 and an inter-model constraint “.+../resource (B)<=6,000”. The inter-model constraints may have interdependency on the resource (B) and the resource (C). The resource (A), resource (B), and resource (C) may represent different types of specification associated with the server-network device 114.

In certain non-limiting embodiments, the client device/network management system 110 may configure the device specification constraint model 1100 with the constraint rules on the resource (A), resource (B), and resource (C) corresponding to a service (X) and a service (Y). The service (X) and service (Y) may be the configurations with which the client device/network management system 110 intends to configure the server-network device 114. The constrain rule “count(/services/service [X])+count(/services/service [Y])<=“may verify that the server-network device 114 has sufficient resources to implement the service (X) and the service (Y).

In certain non-limiting embodiments, the server-network device 114 may fill the device specification data in the device specification data model 1000. As shown, in FIG. 9, the server-network device 114 may fill the device specification data 1200 with the respective specification values associated with the resource (A), resource (B) and resource (C). By way of example, the server-network device 114 may fill the resource list with a value of 50 corresponding to the resource (A), a value of 120 corresponding to the resource (B), a value of 200 corresponding to the resource (C). The server-network device 114 may forward the specification data 1200 to the client device/network management system 110.

In the above scenario, it is assumed that the server-network device 114 is configured with the 40 services (X) and 70 services (Y). The client device/network management system 110 may receive a new request from a user to configure the server-network device 114 a group of 20 service (Y). The client device/network management system 110 may validate the new request. Based on the above scenario, the client device/network management system 110 may reject the new request of the configuration of the server-network device 114 due to validation failure of the device specification constraint model 1100 corresponding to the resource (A) and resource (B). In the above scenario, the configuration request may be rejected before any configuration is sent towards to the server-network device 114.

It is to be noted that various non-limiting embodiments may assist in simplifying software development for both the client device/network management system 110 and the server-network device 114. Using device specification data model and device specification constraint model to decouple the client device/network management system 110 and the server-network device 114 may simplify the management interface, eliminate hard coded rules, hidden protocols, manual co-ordination, while keeping the client device/network management system 110 to be device specification aware, in a clear, well-documented way, and improving the correctness and consistency.

Various non-limiting embodiments of the present disclosure may be backward compatible and inter-operational and may interoperate with peer devices which are not configured with the data models discussed in the present disclosure.

It is to be understood that the operations and functionality of environment 100, constituent components, and associated processes may be achieved by any one or more of hardware-based, software-based, and firmware-based elements. Such operational alternatives do not, in any way, limit the scope of the present disclosure.

It will also be understood that, although the embodiments presented herein have been described with reference to specific features and structures, it is clear that various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

What is claimed is:

1. A method comprising:
creating a specification data type using yet another next generation (YANG) language for indicating device specification data associated with a network device;
creating a YANG based device specification data model using the specification data type;
creating a YANG based device specification constraint model; and
sharing the device specification data model and the device specification constraint model with a network management system and the network device.

2. The method of claim 1, wherein the device specification data includes mixed characteristics of configuration data and state data associated with the device specification model.

3. The method of claim 1, wherein the device specification data assists the network management system and the network device in validating the configuration data.

4. The method of claim 1, wherein creating the specification data type comprises setting a value of config statement to false in the YANG language, creating a YANG specification statement, and setting a value of the specification statement to true.

5. The method of claim 1, wherein the device specification data model defines device specifications associated with the network device.

6. The method of claim 1, wherein the device specification constraint model defines constraints rules in accordance with which the network management system configures the network device.

7. The method of claim 2, wherein the device specification data assists the network management system and the network device in validating the configuration data.

8. The method of claim 2, wherein creating the specification data type comprises setting a value of config statement to false in the YANG language, creating a YANG specification statement, and setting a value of the specification statement to true.

9. A method comprising:
creating, by a network management system, a connection request to a network device;
confirming, by the network management system, a connection to the network device;
receiving, by the network management system, device specification data associated with the network device, wherein:
the device specification data is filled in a yet another next generation (YANG) based device specification data model using a specification data type, the specification data type indicating device specifications associated with the network device; and
storing the device specification data in a datastore.

10. The method of claim 9 further comprising:
receiving, by the network management system, a configuration request;
determining, by the network management system, when there is a requirement to compute a new configuration corresponding to the configuration request; and
in the event of determining that the new configuration is to be computed,
computing, by the network management system, the new configuration based on the device specification data and constraint rules defined in a yet another next generation (YANG) based device specification constraint model, and
sending, by the network management system, the new configuration to the network device; and
in the event of determining that the new configuration is not to be computed,
validating, by the network management system, a configuration associated with the configuration request based on the constraint rules and the device specification data,
when the configuration is validated, sending, by the network management system, the configuration to the network device, and
when the configuration is not validated, rejecting, by the network management system, the configuration request.

11. The method of claim 10 further comprising:
determining, by the network management system, a communication path from the network management system to the network device,
when the communication path is determined, sending, by the network management system, at least one of the configuration and the new configuration to the network device,
when the communication path is not determined, rejecting, by the network management system, the configuration request.

12. The method of claim 10, wherein validating the configuration comprising:
determining, by the network management, based on the device specification data stored in the datastore, that the network device has sufficient resources to implement the configuration.

13. The method of claim 9 further comprising updating the datastore with an updated device specification data received from the network device.

14. The method of claim 11, wherein validating the configuration comprising:
determining, by the network management, based on the device specification data stored in the datastore, that the network device has sufficient resources to implement the configuration.

15. The method of claim 10 further comprising updating the datastore with an updated device specification data received from the network device.

16. The method of claim 11 further comprising updating the datastore with an updated device specification data received from the network device.

17. A method comprising:
including, in a network device, a yet another next generation (YANG) based device specification data model and a YANG based device specification constraint model, wherein:
the device specification data model includes a specification data type that defines device specifications associated with the network device, and
the device specification constraint model defines constraints rules in accordance with which a network management system configures the network device with a configuration;
filling, by the network device, a device specification data in the specification data model using the specification data type;
receiving, by the network device, a connection request from the network management system;
confirming, by the network device, a connection to the network management system; and
sending, by the network device, the device specification data to the network management system.

18. The method of claim 17 further comprising:
receiving, by the network device, the configuration from the network management system;
validating, by the network device, the configuration in accordance with a configuration model,
when the configuration is validated in accordance with the configuration model,
validating, by the network device, in accordance with the device specification data model and the device specification constraint model,
when the configuration is validated in accordance with the device specification data model and the device specification constraint model, accepting, by the network device, the configuration, and
when the configuration is not validated in accordance with the device specification data model and the device specification constraint model, rejecting, by the network device, the configuration; and
when the configuration is not validated in accordance with the configuration model, rejecting, by the network device, the configuration request.

19. The method of claim 17 further comprising:
detecting, by the network device, any update in the device specifications associated the network device;
updating, by the network device, a datastore with updated device specification data; and
sending, by the network device, the updated device specification data to the network management system.

20. The method of claim 18 further comprising:
detecting, by the network device, any update in the device specifications associated the network device;
updating, by the network device, a datastore with updated device specification data; and
sending, by the network device, the updated device specification data to the network management system.
